(19) United States
(12) Patent Application Publication
(10) Pub. No.: US 2020/0355548 A1
(43) Pub. Date: Nov. 12, 2020

(54) PIEZOELECTRIC ACCELERATION SENSOR FOR VIBRATION CONDITION MONITORING

(71) Applicant: FATRI (Xiamen) Technologies, Co., Ltd., Xiamen City (CN)

(72) Inventors: Nie Yongzhong, Xiamen City (CN); Su Weijun, Xiamen City (CN)

(21) Appl. No.: 16/517,979

(22) Filed: Jul. 22, 2019

(30) Foreign Application Priority Data
May 10, 2019 (CN) 201920671158.X

(51) Int. Cl. G01H 11/08; G01P 15/09

(52) U.S. Cl. CPC G01H 11/08; G01P 15/0915

(57) ABSTRACT

The present application refers to the field of acceleration sensors, in particular to a piezoelectric acceleration sensor for vibration condition monitoring, comprising a sensor body, comprising a bracket (1), a piezoelectric ceramic (2) and a mass block (3) successively sleeved on the bracket (1) from inside to outside, and a circuit board (4) connected to the mass block (3); wherein, a relative displacement between the mass block (3) and the piezoelectric ceramic (2) is caused by shearing action when the mass block (3) and the piezoelectric ceramic (2) are subjected to a vibration acceleration generated by the vibration member, so as to cause the piezoelectric ceramic (2) to generate charge to be output to the circuit board (4) via the mass block (3); a signal output component, coupled to the circuit board (4), for converting the charge received by the circuit board (4) before outputting.

### CROSS REFERENCE TO RELATED APPLICATIONS

This application claims priority to Chinese Patent Application No. 201920671158X, filed on May 10, 2019, the entire contents of which are incorporated herein by reference.

### TECHNICAL FIELD

The present application refers to the field of acceleration sensors, in particular to a piezoelectric acceleration sensor for vibration condition monitoring.

### BACKGROUND

The condition of a cutter is a key factor affecting the quality and efficiency of precision cutting process of components. During the cutting process, due to the combined effects of cutting force, cutting in and cutting out impact, etc., the cutter and the co-constructed contact surface may experience complex changes of stress field and temperature field, resulting in wear and damage, thereby degrading the quality of the machined surface and reducing the dimensional accuracy of the components and the machining efficiency of the machine. For example, titanium alloys, superalloys, and complex materials commonly used in aerospace manufacturing are more prone to damage, wear and edge of the tool than other materials due to their high cutting resistance and low thermal conductivity. It is understood that the tool wear has a great influence on the surface quality and dimensional accuracy of the work piece, and even causes greater damage.

### SUMMARY

Therefore, the technical problem to be solved by the present application is to overcome the defects in the prior art that the vibration state of the vibration member is not easily detected in time, thereby affecting the quality of the work piece, so as to provide a piezoelectric acceleration sensor capable of accurately monitoring the vibration condition of a vibration member.

In order to solve the above technical problems, the present application provides a piezoelectric acceleration sensor for vibration condition monitoring, under which a vibration member is disposed, comprising:
a sensor body, comprising a bracket, a piezoelectric ceramic and a mass block successively sleeved on the bracket from inside to outside, and a circuit board connected to the mass block; wherein, a relative displacement between the mass block and the piezoelectric ceramic is caused by shearing action when the mass block and the piezoelectric ceramic are subjected to a vibration acceleration generated by the vibration member, such that the piezoelectric ceramic is caused to generate charge to be output to the circuit board via the mass block;
a signal output component, coupled to the circuit board, for converting the charge received by the circuit board before outputting.

In the piezoelectric acceleration sensor for vibration condition monitoring, the bracket comprises a base, and a support post provided on the base; the piezoelectric ceramic and the mass block are both annular, and are successively sleeved on the support post from inside to outside.

In the piezoelectric acceleration sensor for vibration condition monitoring, a groove body for accommodating the piezoelectric ceramic is formed on an outer wall of the support post.

In the piezoelectric acceleration sensor for vibration condition monitoring, the mass block has an inner diameter slightly larger than an outer diameter of the piezoelectric ceramic, so as to allow the mass block to produce a shearing action along a contact surface between the mass block and the piezoelectric ceramic under an action of vibration acceleration, and apply a shearing force to the piezoelectric ceramic.

The piezoelectric acceleration sensor for vibration condition monitoring further comprises an insulating sheet disposed under the bracket.

The piezoelectric acceleration sensor for vibration condition monitoring further comprises a shield case, inside which the sensor body and the insulating sheet are disposed.

In the piezoelectric acceleration sensor for vibration condition monitoring, the signal output component comprises a cable connected to the circuit board and a two-core connector connected to the cable.

The piezoelectric acceleration sensor for vibration condition monitoring further comprises a protective tube sleeved on the cable.

The piezoelectric acceleration sensor for vibration condition monitoring further comprises an adapter assembly for connecting the protective tube with the sensor body.

In the piezoelectric acceleration sensor for vibration condition monitoring, the adapter assembly comprises an adapter sleeve formed on an extension portion of the sensor body and an adapter for connecting the adapter sleeve with the protection tube.

The technical solutions of the present application have the following advantages.

1. In the piezoelectric acceleration sensor for vibration condition monitoring provided in the present application, a piezoelectric ceramic and a mass block are successively sleeved on a bracket from inside to outside, a circuit board is connected to the mass block, and a signal output component is coupled to the circuit board. Thus, when the vibration member vibrates, the bracket, the piezoelectric ceramic, and the mass block will vibrate to some extent. When a vibration acceleration is generated by the vibration member, a relative displacement between the mass block and the piezoelectric ceramic is caused by shearing action, and then a shearing force is applied to the piezoelectric ceramic. The piezoelectric ceramic converts the vibration force and the shearing force into a charge, which is outputted to the circuit board via the mass block, and the circuit board converts the charge into a voltage outputted via the signal output component, thereby realizing real-time monitoring of the vibration condition of the vibration member, and the output signal is stable, accurate and highly sensitive.

2. In the piezoelectric acceleration sensor for vibration condition monitoring provided in the present application, the mass block has an inner diameter slightly larger than an outer diameter of the piezoelectric ceramic. Thus, the mass block and the piezoelectric ceramic, when not being subjected to vibration caused by an external force, can keep relatively stationary; and when being subjected to vibration, the mass block may produce a shearing action along a contact surface between the mass block and the piezoelectric ceramic under an action of vibration acceleration, and apply a shearing force to the piezoelectric ceramic. So that the piezoelectric ceramic may convert even a small external vibration into an effective electrical signal and output, thereby improving the sensitivity of detection.

3. In the piezoelectric acceleration sensor for vibration condition monitoring provided in the present application, the insulating sheet disposed under the bracket and the external shield case make the core components of the sensor insulate from the outside, thereby effectively preventing external interference and improving the signal-to-noise ratio.

### BRIEF DESCRIPTION OF THE DRAWING

One or more embodiments are illustrated by way of example, and not by limitation, in the figures of the accompanying drawings, wherein elements having the same reference numeral designations represent like elements throughout. The drawings are not to scale, unless otherwise disclosed.

In order to more clearly illustrate the technical solutions of the embodiments of the present application or the prior art, the drawings used in the embodiments of the present application or the prior art will be briefly described below. Obviously, the drawings in the following description are only some embodiments of the present application, and those skilled in the art can obtain other drawings based on these drawings without any creative efforts.

FIG. 1 is a schematic view of a piezoelectric acceleration sensor for vibration condition monitoring;

FIG. 2 is a cross-sectional view of FIG. 1;

FIG. 3 is an enlarged schematic view of the sensor body of FIG. 2.

In the drawings, the reference numerals are:

1—bracket ; 2—piezoelectric ceramic; 3—mass block; 4—circuit board; 5—insulating sheet; 6—shield case; 7—cable; 8—two-core connector; 9—protective tube; 10—adapter assembly; 11—base; 12—support post; 101—adapter sleeve; 102—adapter.

### DETAILED DESCRIPTION

The technical solutions of the present application will be described clearly and completely with reference to the accompanying drawings. It is obvious that the described embodiments are only a part of the embodiments of the present application, and not all of the embodiments. All other embodiments obtained by those skilled in the art based on the embodiments of the present application without any creative efforts are within the scope of the present application.

Further, the technical features involved in the different embodiments of the present application described below may be combined with each other as long as they do not constitute a conflict with each other.

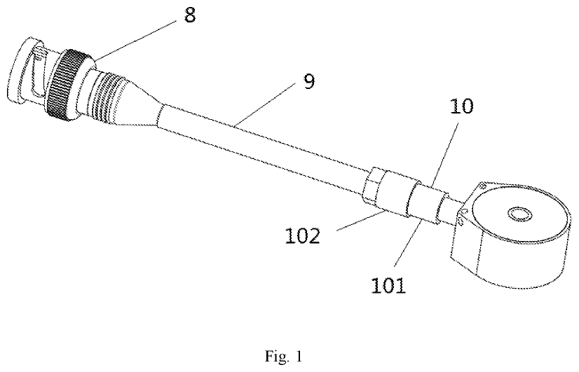

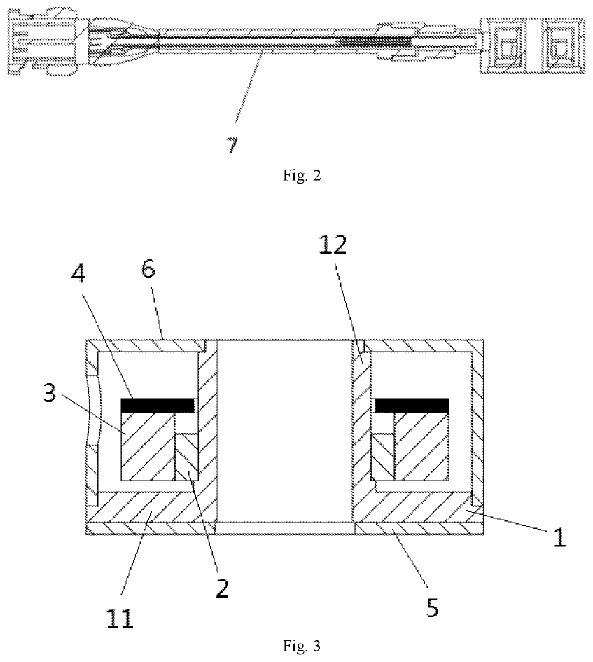

As shown in FIGS. 1-3, provided a specific embodiment of a piezoelectric acceleration sensor for vibration condition monitoring, under which a tool to be monitored is disposed. The piezoelectric acceleration sensor is mounted on the machine processing platform, and comprises a sensor body and a signal output component. The sensor body comprises a bracket 1, a piezoelectric ceramic 2 and a mass block 3 successively sleeved on the bracket 1 from inside to outside, and a circuit board 4 connected to the mass block 3. The sensor body is disposed in a casing, the bracket 1 is fixed on the bottom wall of the casing, and the piezoelectric ceramic 2 and the mass block 3 are suspended inside the casing, that is, not disposed in contact with the top wall and the bottom wall of the casing, and the circuit board 4 is disposed on the mass block 3. The piezoelectric ceramic 2 is fixed with the bracket 1. A relative displacement between the mass block 3 and the piezoelectric ceramic 2 is caused by shearing action when the mass block 3 and the piezoelectric ceramic 2 are subjected to a vibration acceleration generated by the vibration member, thereby generating a shearing force on the contact surface between the mass block 3 and the piezoelectric ceramic 2, which causes the piezoelectric ceramic 2 to be not only subjected to the vibration caused by an external force, but also subjected to the shearing force applied by the mass block 3, thereby increasing the charge outputted signal source and enhancing the sensitivity. The charge generated by the piezoelectric ceramic 2 is outputted to the circuit board 4 via the mass block 3. The signal output component is coupled to the circuit board 4 for converting the charge received by the circuit board 4 before outputting, and the monitor displays the received signal in real time for monitoring.

As a specific embodiment, the bracket 1 comprises a base 11 and a support post 12 disposed on the base 11. The support post 12 is integrally formed in the center of the base 11, and the entire bracket 1 is in an inverted “T” shape. The piezoelectric ceramic 2 and the mass block 3 are both annular, and are successively sleeved on the support post 12 from inside to outside. Specifically, a groove body for accommodating the piezoelectric ceramic 2 is formed on an outer wall of the support post 12, and the piezoelectric ceramic 2 is embedded in the groove body to ensure relatively stationary of the piezoelectric ceramic 2 and the bracket 1.

In order to ensure that the relatively stationary of the mass block 3 and the piezoelectric ceramic 2 may occur when not being subjected to an external force, and a certain mutual shear may be occurred when being subjected to the vibration acceleration, the mass block 3 has an inner diameter slightly larger than an outer diameter of the piezoelectric ceramic 2, and is made of 316L stainless steel, so as to allow the mass block 3 to produce a shearing action along a contact surface between the mass block 3 and the piezoelectric ceramic 2 under an action of inertia force, and apply a shearing force to the piezoelectric ceramic 2.

In order to isolate and insulate the core component inside the sensor body from the outside, an insulating sheet 5 is disposed under the bracket 1, and a shield case 6 is disposed outside the sensor body and the insulating sheet 5. The insulating sheet 5 is completely covered on the bottom wall of the shield case 6. In this embodiment, the insulating sheet 5 is an alumina ceramic insulating spacer.

In order to output the signal converted by the sensor to the outside in a timely and effective manner, the signal output component comprises a cable 7 connected to the circuit board 4 and a two-core connector 8 connected to the cable 7. A protective tube 9 is sleeved on the cable 7, and the protective tube 9 in this embodiment is a stainless steel bellows. An adapter assembly 10 is further disposed between the protective tube 9 and the sensor body, and comprises an adapter sleeve 101 formed on the extension portion of the sensor body and an adapter 102 for connecting the adapter sleeve 101 with the stainless steel bellows. The adapter sleeve 101 is used to protect the cable 7 connected to the two-core connector 8 from being pulled. The cable is applied with 7EHX44 glue and crimped with a crimping device for better protection.

Firstly, a certain amount of vibration may be occurred when the tool wears, the piezoelectric ceramic generates charge outputted through the vibration of the tool. Then, the signal is converted by an integrated signal conditioning circuit board, and the charge outputted is converted into a voltage output, which is correspondingly amplified. Finally, the amplified voltage output is connected to the two-core connector via the external cable to complete the signal acquisition and transmission. The online monitoring technology is used to collect and analyze the sensor information in the machining process to timely and accurately identify the occurrence of tool damage and the state of tool wear. On this basis, the evolution trend of tool wear and the remaining life of the tool are predicted. Therefore, measures such as changing the tool in advance and changing the cutting parameters can be taken to reduce the influence of tool wear on the surface quality and dimensional accuracy of the work piece, and emergency measures such as shutdown can be taken to avoid greater damage to the work piece and the machine.

It is apparent that the above embodiments are merely examples for clarity of illustration, and are not intended to limit the embodiments. Other variations or modifications of the various forms may be made by those skilled in the art in view of the above description. There is no need and no way to present all of the embodiments.

The obvious variations or modifications derived therefrom are still within the scope of protection created by the present application.

What is claimed is:

1. A piezoelectric acceleration sensor for vibration condition monitoring, under which a vibration member is disposed, characterized in comprising:
a sensor body, comprising a bracket, a piezoelectric ceramic and a mass block successively sleeved on the bracket from inside to outside, and a circuit board connected to the mass block; wherein, a relative displacement between the mass block and the piezoelectric ceramic is caused by shearing action when the mass block and the piezoelectric ceramic are subjected to a vibration acceleration generated by the vibration member, so as to cause the piezoelectric ceramic to generate charge to be output to the circuit board via the mass block;
a signal output component, coupled to the circuit board, for converting the charge received by the circuit board before outputting.

2. The piezoelectric acceleration sensor for vibration condition monitoring according to claim 1, characterized in that
the bracket comprises a base, and a support post provided on the base;
the piezoelectric ceramic and the mass block are both annular, and are successively sleeved on the support post from inside to outside.

3. The piezoelectric acceleration sensor for vibration condition monitoring according to claim 2, characterized in that a groove body for accommodating the piezoelectric ceramic is formed on an outer wall of the support post.

4. The piezoelectric acceleration sensor for vibration condition monitoring according to claim 3, characterized in that the mass block has an inner diameter slightly larger than an outer diameter of the piezoelectric ceramic, so as to allow the mass block to produce a shearing action along a contact surface between the mass block and the piezoelectric ceramic under an action of vibration acceleration, and apply a shearing force to the piezoelectric ceramic.

5. The piezoelectric acceleration sensor for vibration condition monitoring according to claim 1, further comprising an insulating sheet disposed under the bracket.

6. The piezoelectric acceleration sensor for vibration condition monitoring according to claim 5, further comprising a shield case, inside which the sensor body and the insulating sheet are disposed.

7. The piezoelectric acceleration sensor for vibration condition monitoring according to claim 1, characterized in that the signal output component comprises a cable connected to the circuit board and a two-core connector connected to the cable.

8. The piezoelectric acceleration sensor for vibration condition monitoring according to claim 7, characterized in further comprising a protective tube sleeved on the cable.

9. The piezoelectric acceleration sensor for vibration condition monitoring according to claim 8, characterized in further comprising an adapter assembly for connecting the protective tube with the sensor body.

10. The piezoelectric acceleration sensor for vibration condition monitoring according to claim 9, characterized in that the adapter assembly comprises an adapter sleeve formed on an extension portion of the sensor body and an adapter for connecting the adapter sleeve with the protection tube.

11. The piezoelectric acceleration sensor for vibration condition monitoring according to claim 2, further comprising an insulating sheet disposed under the bracket.

12. The piezoelectric acceleration sensor for vibration condition monitoring according to claim 3, further comprising an insulating sheet disposed under the bracket.

13. The piezoelectric acceleration sensor for vibration condition monitoring according to claim 4, further comprising an insulating sheet disposed under the bracket.

14. The piezoelectric acceleration sensor for vibration condition monitoring according to claim 2, characterized in that the signal output component comprises a cable connected to the circuit board and a two-core connector connected to the cable.

15. The piezoelectric acceleration sensor for vibration condition monitoring according to claim 3, characterized in that the signal output component comprises a cable connected to the circuit board and a two-core connector connected to the cable.

16. The piezoelectric acceleration sensor for vibration condition monitoring according to claim 4, characterized in that the signal output component comprises a cable connected to the circuit board and a two-core connector connected to the cable.
